(19) United States
(12) Patent Application Publication
(10) Pub. No.: US 2026/0110282 A1
(43) Pub. Date: Apr. 23, 2026

(54) EXHAUST GAS RECIRCULATION SYSTEM

(71) Applicants: TOYOTA JIDOSHA KABUSHIKI KAISHA, Toyota-shi (JP); KABUSHIKI KAISHA TOYOTA JIDOSHOKKI, Kariya-shi (JP)

(72) Inventors: Masaomi TAKANO, Nisshin-shi (JP); Yoshito CHIKASUE, Kariya-shi (JP)

(73) Assignees: TOYOTA JIDOSHA KABUSHIKI KAISHA, Toyota-shi (JP); KABUSHIKI KAISHA TOYOTA JIDOSHOKKI, Kariya-shi (JP)

(21) Appl. No.: 19/359,475

(22) Filed: Oct. 15, 2025

(30) Foreign Application Priority Data
Oct. 21, 2024 (JP) 2024-185155

(51) Int. Cl. F02M 26/07; F02D 41/00; F02M 26/09; F02M 26/33

(52) U.S. Cl. CPC F02M 26/07; F02D 41/0047; F02M 26/09; F02M 26/33

(57) ABSTRACT

An exhaust gas recirculation system includes a high-pressure EGR device, a low-pressure EGR device, and a controller. The high-pressure EGR device includes a high-pressure EGR passage connected to a section of the intake passage downstream of a compressor. The low-pressure EGR device includes a low-pressure EGR passage connected to a section of the intake passage upstream of the compressor. The controller identifies an operating region of the internal combustion engine, and calculates a residual amount, which is an estimated value of an amount of condensed water remaining in the low-pressure EGR passage. When the residual amount is greater than a determination value corresponding to the operating region, the controller operates the low-pressure EGR device so as to reduce a recirculation amount of low-pressure EGR gas.

### CROSS-REFERENCE TO RELATED APPLICATIONS

This application is based upon and claims the benefit of priority from Japanese Patent Application No. 2024-185155, filed on Oct. 21, 2024, the entire contents of which are incorporated herein by reference.

### BACKGROUND

### 1. Field

The present disclosure relates to an exhaust gas recirculation system provided in an internal combustion engine.

### 2. Description of Related Art

JP2012-163061A discloses an exhaust gas recirculation system that includes a high-pressure EGR device, a low-pressure EGR device, and a controller. The high-pressure EGR device includes a high-pressure EGR passage, which recirculates exhaust gas flowing through the exhaust passage of the internal combustion engine to the intake passage as high-pressure EGR gas, and an adjustment valve, which adjusts the recirculation amount of the high-pressure EGR gas. The high-pressure EGR passage is connected to a section of the intake passage downstream of the compressor of a forced-induction device.

The low-pressure EGR device includes a low-pressure EGR passage, which recirculates the exhaust gas flowing through the exhaust passage to the intake passage as low-pressure EGR gas, a cooling device, which cools the low-pressure EGR gas flowing through the low-pressure EGR passage, and an adjustment valve that adjusts the recirculation amount of the low-pressure EGR gas. The low-pressure EGR passage is connected to a section of the intake passage upstream of the compressor of the forced-induction device.

In the low-pressure EGR passage, condensed water is generated by the cooling device cooling the low-pressure EGR gas. When the flow velocity of the low-pressure EGR gas within the low-pressure EGR passage is relatively high, the condensed water is entrained with the low-pressure EGR gas and discharged into the intake passage. In contrast, when the flow velocity of the low-pressure EGR gas within the low-pressure EGR passage is relatively low or when the flow of the low-pressure EGR gas within the low-pressure EGR passage is halted, the condensed water flows by gravity toward a first end of the low-pressure EGR passage. Then, the condensed water is discharged into the exhaust passage.

When an estimated value of the amount of the condensed water accumulated in the low-pressure EGR passage exceeds a reference value, the controller operates the adjustment valve of the high-pressure EGR device and the adjustment valve of the low-pressure EGR passage such that the ratio of the low-pressure EGR gas to the total amount of the EGR gas recirculated to the intake passage is reduced. Accordingly, by discharging condensed water from the low-pressure EGR passage to the exhaust passage, the controller reduces the amount of condensed water remaining in the low-pressure EGR passage.

Depending on the operating state of the internal combustion engine, recirculating low-pressure EGR gas to the intake passage provides a greater reduction in NOx contained in the exhaust gas of the internal combustion engine than recirculating high-pressure EGR gas to the intake passage. However, in the above-described exhaust gas recirculation system, even when the engine operating state would favor NOx reduction through recirculation of low-pressure EGR gas to the intake passage, the amount of low-pressure EGR gas recirculated to the intake passage decreases if the amount of condensed water in the low-pressure EGR passage exceeds the reference value. Therefore, the exhaust gas recirculation system has room for improvement in terms of suppressing a decrease in NOx reduction effect.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an exhaust gas recirculation system is configured to be provided in an internal combustion engine including a cylinder, an intake passage through which air introduced into the cylinder flows, an exhaust passage through which exhaust gas discharged from the cylinder flows, and a forced-induction device that compresses the air flowing through the intake passage. The forced-induction device includes a turbine provided in the exhaust passage and a compressor provided in the intake passage and operates in synchronization with the turbine. The exhaust gas recirculation system includes a high-pressure EGR device that recirculates exhaust gas flowing through the exhaust passage to the intake passage as high-pressure EGR gas, a low-pressure EGR device that recirculates exhaust gas flowing through the exhaust passage to the intake passage as low-pressure EGR gas, and a controller configured to control the high-pressure EGR device and the low-pressure EGR device so as to adjust a recirculation amount of the high-pressure EGR gas and a recirculation amount of the low-pressure EGR gas. The high-pressure EGR device includes a high-pressure EGR passage. A first end of the high-pressure EGR passage is connected to a section of the exhaust passage upstream of the turbine. A second end of the high-pressure EGR passage is connected to a section of the intake passage downstream of the compressor. The low-pressure EGR device includes a low-pressure EGR passage and a cooling device. A first end of the low-pressure EGR passage is connected to a section of the exhaust passage downstream of the turbine. A second end of the low-pressure EGR passage is connected to a section of the intake passage upstream of the compressor. The cooling device cools the low-pressure EGR gas flowing through the low-pressure EGR passage. The controller is configured to identify an operating region of the internal combustion engine based on an output torque and an engine rotation speed of the internal combustion engine, calculate a residual amount that is an estimated value of an amount of condensed water remaining in the low-pressure EGR passage, and when the residual amount is greater than a determination value corresponding to the operating region, operate the low-pressure EGR device so as to reduce the recirculation amount of the low-pressure EGR gas.

The exhaust gas recirculation system described above provides the advantageous effect of enabling discharge of condensed water generated in the low-pressure EGR passage into the exhaust passage, while suppressing a decrease in the effect of NOx reduction in exhaust gas.

Other features and aspects will be apparent from the following detailed description, the drawings, and the claims.

### BRIEF DESCRIPTION OF THE DRAWINGS

FIG. 1 is a schematic diagram showing an internal combustion engine provided with an exhaust gas recirculation system according to an embodiment.

FIG. 2 is a diagram showing operating regions of the internal combustion engine shown in FIG. 1.

FIG. 3 is a diagram showing the relationship between multiple operating regions in FIG. 2 and determination values.

FIG. 4 is a flowchart showing a series of processes executed by a controller included in the exhaust gas recirculation system shown in FIG. 1.

FIG. 5 is a block diagram showing a calculation process for condensed water.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

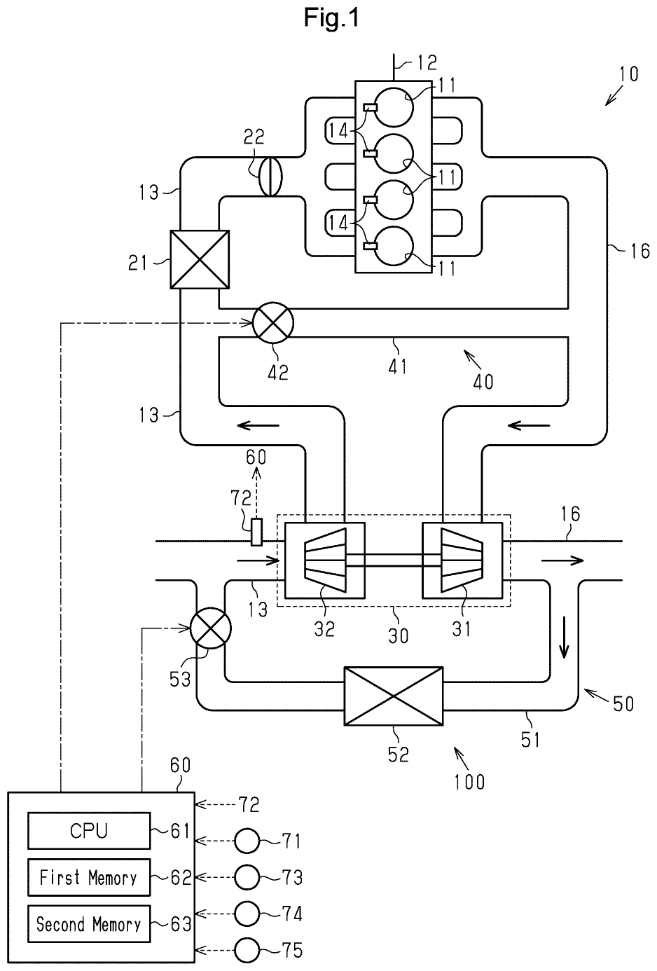

An exhaust gas recirculation system 100 according to an embodiment will now be described with reference to FIGS. 1 to 5.

### Configuration of the Internal Combustion Engine

FIG. 1 shows an internal combustion engine 10 equipped with the exhaust gas recirculation system 100. The internal combustion engine 10 is mounted on a vehicle. The internal combustion engine 10 includes multiple cylinders 11, a crankshaft 12, an intake passage 13, multiple fuel injection valves 14, and an exhaust passage 16.

The intake passage 13 is a passage through which air drawn into the cylinders 11 flows. The intake passage 13 includes an intercooler 21 and a throttle valve 22. The intercooler 21 cools the air flowing through the intake passage 13. The throttle valve 22 is disposed in a section of the intake passage 13 downstream of the intercooler 21. By adjusting the opening degree of the throttle valve 22, the amount of air introduced into the cylinders 11 is varied.

Each fuel injection valve 14 injects fuel into the corresponding cylinder 11. In each cylinder 11, air-fuel mixture containing air and fuel is burned. Accordingly, the crankshaft 12 rotates. The combustion of the air-fuel mixture generates exhaust gas in the cylinders 11. The exhaust gas discharged from the cylinders 11 flows through the exhaust passage 16.

The internal combustion engine 10 includes a forced-induction device 30. The forced-induction device 30 includes a turbine 31 provided in the exhaust passage 16 and a compressor 32 provided in the intake passage 13. The turbine 31 operates based on the flow dynamics of exhaust gas passing through the exhaust passage 16. The compressor 32 is disposed in a section of the intake passage 13 downstream of the intercooler 21. The compressor 32 operates in synchronization with the turbine 31, thereby pressurizing the air flowing through the intake passage 13.

### Configuration of the Exhaust Gas Recirculation System

The exhaust gas recirculation system 100 includes a high-pressure EGR device 40, a low-pressure EGR device 50, and a controller 60.

The high-pressure EGR device 40 recirculates exhaust gas flowing through the exhaust passage 16 to a section of the intake passage 13 downstream of the compressor 32, such that the recirculated exhaust gas functions as high-pressure EGR gas. The high-pressure EGR device 40 includes a high-pressure EGR passage 41 that connects the exhaust passage 16 to the intake passage 13, and a high-pressure EGR valve 42 that is installed in the high-pressure EGR device 40. A first end of the high-pressure EGR passage 41 is connected to a section of the exhaust passage 16 upstream of the turbine 31. A second end of the high-pressure EGR passage 41 is connected to a section of the intake passage 13 downstream of the compressor 32. For example, the second end of the high-pressure EGR passage 41 is connected to a section of the intake passage 13 between the compressor 32 and the intercooler 21.

The high-pressure EGR valve 42 is an electronically controlled valve. The opening degree of the high-pressure EGR valve 42 is controlled by the controller 60, which will be discussed below. As the opening degree of the high-pressure EGR valve 42 increases, the amount of the high-pressure EGR gas recirculated to the intake passage 13 by the high-pressure EGR device 40 increases. In contrast, when the high-pressure EGR valve 42 is closed, the recirculation of the high-pressure EGR gas to the intake passage 13 by the high-pressure EGR device 40 is stopped.

The low-pressure EGR device 50 recirculates exhaust gas flowing through the exhaust passage 16 to a section of the intake passage 13 upstream of the compressor 32, such that the recirculated exhaust gas functions as low-pressure EGR gas. The low-pressure EGR device 50 includes a low-pressure EGR passage 51 that connects the exhaust passage 16 to the intake passage 13, and a cooling device 52 and a low-pressure EGR valve 53 that are disposed in the low-pressure EGR passage 51. A first end of the low-pressure EGR passage 51 is connected to a section of the exhaust passage 16 downstream of the turbine 31. A second end of the low-pressure EGR passage 51 is connected to a section of the intake passage 13 upstream of the compressor 32.

In a state in which the internal combustion engine 10 is mounted on the vehicle, the first end of the low-pressure EGR passage 51 is located below the second end of the low-pressure EGR passage 51. For example, the low-pressure EGR passage 51 is configured to be positioned higher as it extends toward the intake passage 13 in a state in which the internal combustion engine 10 is mounted on the vehicle.

The cooling device 52 cools the low-pressure EGR gas flowing through the low-pressure EGR passage 51.

The low-pressure EGR valve 53 is disposed in a section of the low-pressure EGR passage 51 between the cooling device 52 and a connection point with the intake passage 13. The low-pressure EGR valve 53 is an electronically controlled valve. The opening degree of the low-pressure EGR valve 53 is controlled by the controller 60, which will be discussed below. As the opening degree of the low-pressure EGR valve 53 increases, the amount of the low-pressure EGR gas recirculated to the intake passage 13 by the low-pressure EGR device 50 increases. In contrast, when the low-pressure EGR valve 53 is closed, the recirculation of the low-pressure EGR gas to the intake passage 13 by the low-pressure EGR device 50 is stopped.

The low-pressure EGR gas in the low-pressure EGR passage 51 is cooled by the cooling device 52. Therefore, condensed water is generated in the low-pressure EGR passage 51 due to a decrease in the temperature of the low-pressure EGR gas. When the flow velocity of the low-pressure EGR gas flowing through the low-pressure EGR passage 51 toward the intake passage 13 is relatively high, condensed water is discharged to the intake passage 13 together with the low-pressure EGR gas. In contrast, when the flow velocity of the low-pressure EGR gas flowing through the low-pressure EGR passage 51 toward the intake passage 13 is relatively low, or when the flow of the low-pressure EGR gas is stopped, condensed water flows through the low-pressure EGR passage 51 toward the exhaust passage 16 under its own weight. The condensed water is then discharged to the exhaust passage 16.

The controller 60 controls the high-pressure EGR device 40 and the low-pressure EGR device 50 to adjust the recirculation amount of the high-pressure EGR gas and the recirculation amount of the low-pressure EGR gas. The controller 60 receives detection signals from multiple sensors.

The multiple sensors include a crank angle sensor 71, an air flow meter 72, a coolant temperature sensor 73, an intake air temperature sensor 74, and an exhaust gas temperature sensor 75.

The crank angle sensor 71 detects a rotation angle of the crankshaft 12. The rotation speed of the crankshaft 12 based on a detection signal of the crank angle sensor 71 is referred to as an engine rotation speed NE. The air flow meter 72 detects the flow rate of air in the intake passage 13. The flow rate of air based on a detection signal of the air flow meter 72 is referred to as an intake air amount GA. The coolant temperature sensor 73 detects the temperature of the coolant flowing through the cooling device 52. The temperature of the coolant based on a detection signal of the coolant temperature sensor 73 is referred to as a coolant temperature. The intake air temperature sensor 74 detects the temperature of the air introduced from the intake passage 13 into the multiple cylinders 11. The temperature of the air based on a detection signal of the intake air temperature sensor 74 is referred to as an intake air temperature. The exhaust gas temperature sensor 75 detects the temperature of the exhaust gas flowing through a section of the exhaust passage 16 downstream of the turbine 31. The temperature of the exhaust gas based on a detection signal of the exhaust gas temperature sensor 75 is referred to as an exhaust gas temperature.

An example of the controller 60 is an electronic control unit. In this case, the controller 60 includes a CPU 61, a first memory 62, and a second memory 63. The first memory 62 stores control programs executed by the CPU 61. The second memory 63 stores calculation results of the CPU 61. When the CPU 61 executes a control program in the first memory 62, the controller 60 adjusts the opening degree of the high-pressure EGR valve 42 and the opening degree of the low-pressure EGR valve 53.

### Operating Regions of the Internal Combustion Engine

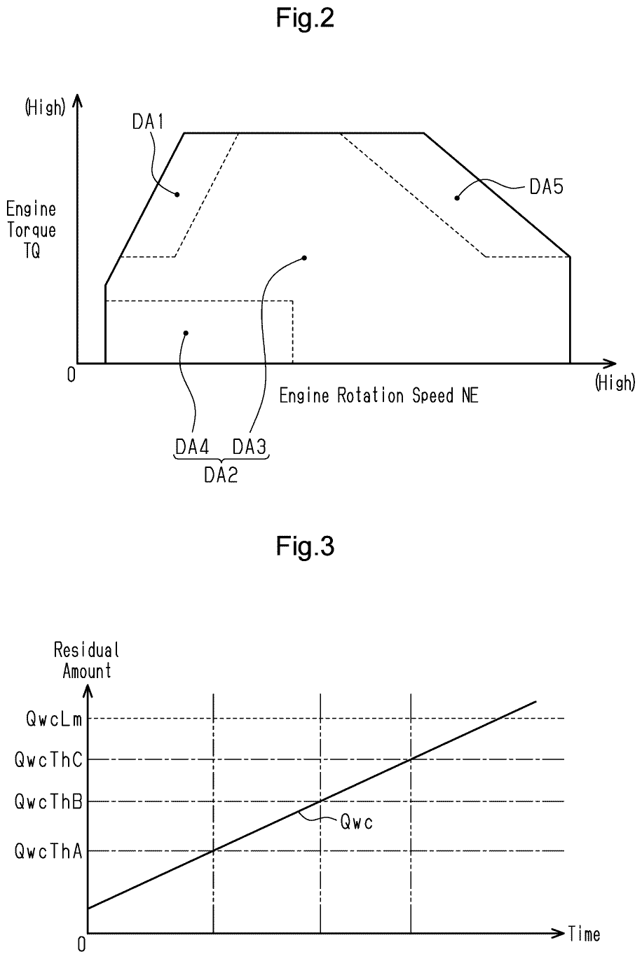

Referring to FIG. 2, a relationship between the operating regions of the internal combustion engine 10 and the mixing ratio of the high-pressure EGR gas and the low-pressure EGR gas will be described. The operating regions of the internal combustion engine 10 are regions determined by an engine torque TQ, which is the output torque of the internal combustion engine 10, and the engine rotation speed NE.

The operating regions of the internal combustion engine 10 include a first operating region DA1, a second operating region DA2, and a fifth operating region DA5. The second operating region DA2 includes a third operating region DA3 and a fourth operating region DA4.

The first operating region DA1 corresponds to a high-torque, low-rotation speed operating condition. In the first operating region DA1, recirculation of the low-pressure EGR gas to the intake passage 13 is permitted, while recirculation of the high-pressure EGR gas to the intake passage 13 is prohibited.

The fifth operating region DA5 corresponds to a high-torque, high-rotation speed operating condition. In the fifth operating region DA5, recirculation of the high-pressure EGR gas to the intake passage 13 is permitted, while recirculation of the low-pressure EGR gas to the intake passage 13 is prohibited.

In the second operating region DA2, both the high-pressure EGR gas and the low-pressure EGR gas are allowed to be recirculated to the intake passage 13. The fourth operating region DA4 corresponds to a low torque, low rotation speed operating condition. In the fourth operating region DA4, the temperature of the high-pressure EGR gas is not significantly high, and the amount of NOx discharged from the cylinders 11 is not significantly large. Therefore, in the fourth operating region DA4, the difference between the effect of reducing the amount of NOx discharged by recirculating the high-pressure EGR gas and the effect of reducing the amount of NOx discharged by recirculating the low-pressure EGR gas is relatively small. In contrast, in the third operating region DA3, the temperature of the high-pressure EGR gas is higher than that in the fourth operating region DA4, resulting in a greater effect of reducing the amount of NOx by recirculating the low-pressure EGR gas. That is, the fourth operating region DA4 is an operating region in which the effect of improving exhaust emission characteristics by recirculating the low-pressure EGR gas into the intake passage 13 is lower than that in the third operating region DA3.

### Control of the High-Pressure EGR Device and the Low-Pressure EGR Device

The controller 60 calculates a residual amount Qwc that is an estimated value of an amount of condensed water remaining in the low-pressure EGR passage 51. When the residual amount Qwc is greater than a determination value, the controller 60 operates the low-pressure EGR device 50 so as to reduce the recirculation amount of the low-pressure EGR gas. For example, the controller 60 controls the low-pressure EGR device 50 and the high-pressure EGR device 40 so as to reduce the proportion of the low-pressure EGR gas in the amount of the EGR gas recirculated to the intake passage 13. The recirculation amount of the EGR gas to the intake passage 13 is the sum of the recirculation amount of the high-pressure EGR gas and the recirculation amount of the low-pressure EGR gas.

In this process, the controller 60 compares the residual amount Qwc with a determination value corresponding to the current operating region. When the operating region is the fourth operating region DA4, the controller 60 operates the low-pressure EGR device 50 to reduce the recirculation amount of the low-pressure EGR gas if the residual amount Qwc exceeds a determination value QwcThA corresponding to the fourth operating region DA4. When the operating region is the third operating region DA3, the controller 60 operates the low-pressure EGR device 50 to reduce the recirculation amount of the low-pressure EGR gas if the residual amount Qwc exceeds a determination value QwcThB corresponding to the third operating region DA3. When the operating region is the first operating region DA1, the controller 60 operates the low-pressure EGR device 50 to reduce the recirculation amount of the low-pressure EGR gas if the residual amount Qwc exceeds a determination value QwcThC corresponding to the first operating region DA1.

As shown in FIG. 3, multiple determination values QwcThA, QwcThB, and QwcThC are used, which are less than a residual amount upper limit QwcLm. The residual amount upper limit QwcLm is an upper limit of the condensed water that can be retained in the low-pressure EGR passage 51.

As described above, the fourth operating region DA4 is an operating region in which the effect of reducing the discharge amount of NOx by recirculating the low-pressure EGR gas is relatively low. The third operating region DA3 is an operating region in which the effect of reducing the discharge amount of NOx by recirculating the low-pressure EGR gas is higher than that in the fourth operating region DA4. The first operating region DA1 is an operating region in which the effect of reducing the discharge amount of NOx by recirculating the low-pressure EGR gas is higher than that in the third operating region DA3 and the fourth operating region DA4.

Accordingly, among the three determination values QwcThA, QwcThB, and QwcThC, the determination value QwcThA is the smallest, the determination value QwcThB is the second smallest, and the determination value QwcThC is the largest.

### Series of Processes Executed by the Controller

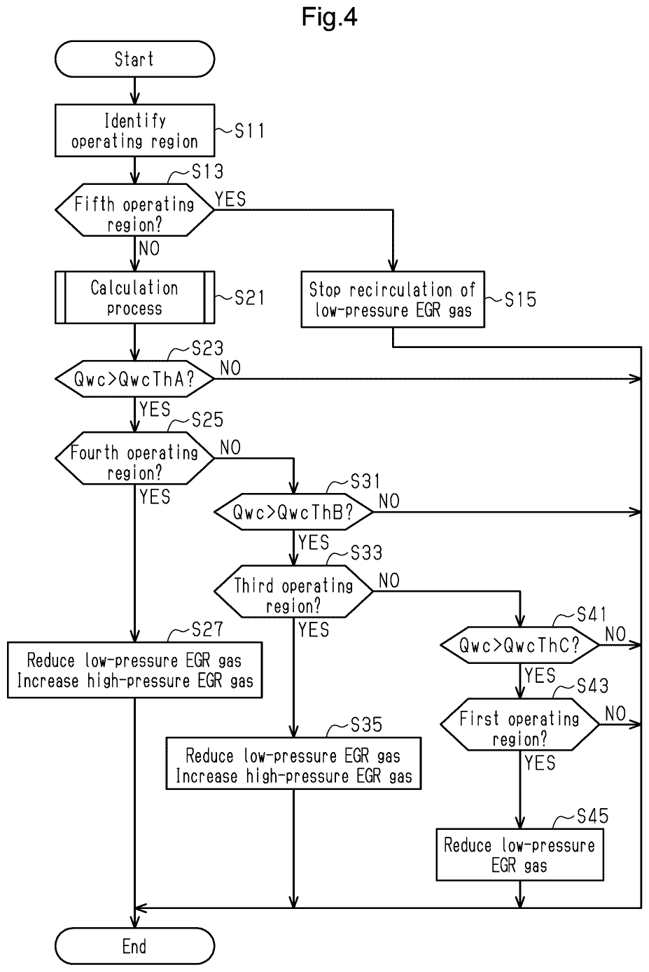

A series of processes executed by the controller 60 in order to operate the high-pressure EGR device 40 and the low-pressure EGR device 50 will be described with reference to FIG. 4. The controller 60 repeatedly executes this sequence at specified control cycles while the internal combustion engine 10 is in operation.

In step S11, the controller 60 identifies the current operating region of the internal combustion engine 10 based on the engine torque TQ and engine rotation speed NE, from among the multiple operating regions DA1, DA3, DA4, and DA5. In step S13, the controller 60 determines whether the operating region identified in step S11 is the fifth operating region DA5. If the current operating region is the fifth operating region DA5 (S13: YES), the controller 60 advances the process to step S15. If the current operating region is not the fifth operating region DA5 (S13: NO), the controller 60 advances the process to step S21.

In step S15, the controller 60 operates the low-pressure EGR device 50 such that recirculation of the low-pressure EGR gas is stopped. For example, the controller 60 closes the low-pressure EGR valve 53. Thereafter, the controller 60 temporarily ends the series of processes.

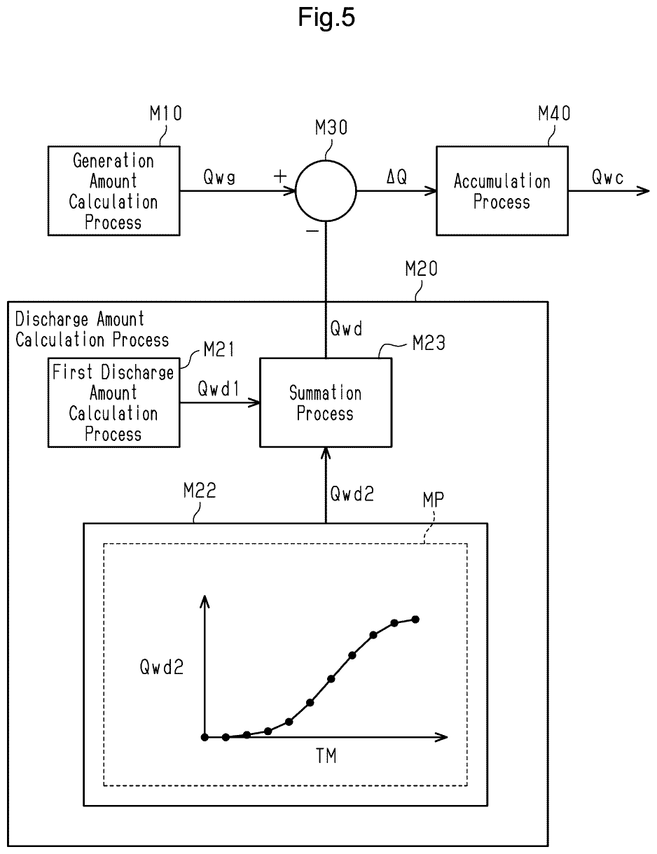

In step S21, the controller 60 calculates the residual amount Qwc, which is an estimated value of the amount of condensed water remaining in the low-pressure EGR passage 51. The process of calculating the residual amount Qwc will be described later with reference to FIG. 5. When the residual amount Qwc is calculated, the controller 60 advances the process to step S23.

In step S23, the controller 60 determines whether the residual amount Qwc calculated in step S21 is greater than the determination value QwcThA, which corresponds to the fourth operating region DA4. When the residual amount Qwc is greater than the determination value QwcThA (S23: YES), the controller 60 advances the process to step S25. When the residual amount Qwc is less than or equal to the determination value QwcThA (S23: NO), the controller 60 temporarily ends the series of processes.

In step S25, the controller 60 determines whether the current operating region identified in step S11 is the fourth operating region DA4. If the current operating region is the fourth operating region DA4 (S25: YES), the controller 60 advances the process to step S27. If the current operating region is not the fourth operating region DA4 (S25: NO), the controller 60 advances the process to step S31.

In step S27, the controller 60 operates the low-pressure EGR device 50 and the high-pressure EGR device 40 so as to reduce the recirculation amount of the low-pressure EGR gas, and increase the recirculation amount of the high-pressure EGR gas. Preferably, the controller 60 stops the recirculation of the low-pressure EGR gas and increases the recirculation amount of the high-pressure EGR gas. At this time, the controller 60 closes the low-pressure EGR valve 53 and increases the opening degree of the high-pressure EGR valve 42. Then, the controller 60 temporarily ends the series of processes.

In step S31, the controller 60 determines whether the residual amount Qwc calculated in step S21 is greater than the determination value QwcThB, which corresponds to the third operating region DA3. When the residual amount Qwc is greater than the determination value QwcThB (S31: YES), the controller 60 advances the process to step S33. In contrast, when the residual amount Qwc is less than or equal to the determination value QwcThB (S31: NO), the controller 60 temporarily ends the series of processes.

In step S33, the controller 60 determines whether the current operating region identified in step S11 is the third operating region DA3. If the current operating region is the third operating region DA3 (S33: YES), the controller 60 advances the process to step S35. If the current operating region is not the third operating region DA3 (S33: NO), the controller 60 advances the process to step S41.

In step S35, the controller 60 operates the low-pressure EGR device 50 and the high-pressure EGR device 40 so as to reduce the recirculation amount of the low-pressure EGR gas, and increase the recirculation amount of the high-pressure EGR gas. Preferably, the controller 60 stops the recirculation of the low-pressure EGR gas and increases the recirculation amount of the high-pressure EGR gas. At this time, the controller 60 closes the low-pressure EGR valve 53 and increases the opening degree of the high-pressure EGR valve 42. Then, the controller 60 temporarily ends the series of processes.

In step S41, the controller 60 determines whether the residual amount Qwc calculated in step S21 is greater than the determination value QwcThC, which corresponds to the first operating region DA1. When the residual amount Qwc is greater than the determination value QwcThC (S41: YES), the controller 60 advances the process to step S43. When the residual amount Qwc is less than or equal to the determination value QwcThC (S41: NO), the controller 60 temporarily ends the series of processes.

In step S43, the controller 60 determines whether the current operating region identified in step S11 is the first operating region DA1. When the current operating region is the first operating region DA1 (S43: YES), the controller 60 advances the process to step S45. When the current operating region is not the first operating region DA1 (S43: NO), the controller 60 temporarily ends the series of processes.

In step S45, the controller 60 operates the low-pressure EGR device 50 such that the recirculation amount of the low-pressure EGR gas decreases. Preferably, the controller 60 stops the recirculation of the low-pressure EGR gas. At this time, the controller 60 closes the low-pressure EGR valve 53. Then, the controller 60 temporarily ends the series of processes.

### Calculation Process of the Residual Amount Qwc

The process of calculating the residual amount Qwc in the step S21 will now be described with reference to FIG. 5. The controller 60 repeatedly executes the calculation process at specified calculation cycles.

The calculation process includes a generation amount calculation process M10, a discharge amount calculation process M20, a difference calculation process M30, and an accumulation process M40.

The generation amount calculation process M10 is a process of calculating a generation amount Qwg, which is an estimated value of the amount of condensed water generated in the low-pressure EGR passage 51 within a unit time. The unit time is equal to, for example, the time length of the execution interval of the process for calculating the residual amount Qwc.

In the generation amount calculation process M10, the controller 60 calculates the generation amount Qwg based on the outside air temperature, the intake air amount, the fuel injection amount, the moisture content in the air, and the like. For example, the controller 60 calculates the moisture content in the exhaust gas flowing through the exhaust passage 16 based on the outside air temperature, the intake air amount, the fuel injection amount, and the moisture content in the air. Then, the controller 60 calculates the difference between this calculated moisture content and the moisture content in the exhaust gas at 100% relative humidity after being cooled in the low-pressure EGR passage 51. This difference is used as the generation amount Qwg.

The discharge amount calculation process M20 is a process of calculating a discharge amount Qwg, which is an estimated value of the amount of condensed water discharged from the low-pressure EGR passage 51 within a unit time. The discharge amount calculation process M20 includes a first discharge amount calculation process M21, a second discharge amount calculation process M22, and a summation process M23.

The first discharge amount calculation process M21 is a process of calculating a first discharge amount Qwd1, which is an estimated value of the amount of condensed water discharged from the low-pressure EGR passage 51 to the intake passage 13 within a unit time.

In the first discharge amount calculation process M21, the controller 60 calculates the first discharge amount Qwd1 based on the flow rate of the low-pressure EGR gas. At this time, the controller 60 calculates the first discharge amount Qwd1 such that the first discharge amount Qwd1 increases as the flow rate of the low-pressure EGR gas increases.

The controller 60 is capable of calculating the flow rate of the low-pressure EGR gas based on the amount of exhaust gas flowing through the exhaust passage 16 and the opening degree of the low-pressure EGR valve 53.

The second discharge amount calculation process M22 is a process of calculating a second discharge amount Qwd2, which is an estimated value of the amount of condensed water discharged from the low-pressure EGR passage 51 to the exhaust passage 16 within a unit time.

In the second discharge amount calculation process M22, the controller 60 calculates the second discharge amount Qwd2 based on the stop time TM, which is the duration of the state in which the low-pressure EGR valve 53 is closed.

There is a correlation between the amount of condensed water discharged from the low-pressure EGR passage 51 to the exhaust passage 16 and the stop time TM. FIG. 5 shows a map MP representing this correlation.

The controller 60 refers to the map MP and derives a value for the second discharge amount Qwd2 based on the stop time TM. This allows the controller 60 to calculate the second discharge amount Qwd2 such that the value increases as the stop time TM becomes longer.

In the summation process M23, the controller 60 calculates the discharge amount Qwd as the sum of the first discharge amount Qwd1 and the second discharge amount Qwd2.

In the difference calculation process M30, the controller 60 calculates a difference ΔQ between the generation amount Qwg and the discharge amount Qwd by subtracting the discharge amount Qwd from the generation amount Qwg. When the generation amount Qwg is greater than the discharge amount Qwd, the difference ΔQ has a positive value. Conversely, when the generation amount Qwg is less than the discharge amount Qwd, the difference ΔQ has a negative value.

In the accumulation process M40, the controller 60 calculates the residual amount Qwc by accumulating values of the difference ΔQ. However, if the integrated value of the differential ΔQ is negative, the controller 60 sets the residual amount Qwc to zero.

### Operation and Advantages of the Present Embodiment

(1) The NOx reduction effect achieved by recirculating the low-pressure EGR gas into the intake passage 13 varies depending on the operating region of the internal combustion engine 10. Accordingly, in an operating region in which the NOx reduction effect by recirculating low-pressure EGR gas into the intake passage 13 is relatively low, executing control to reduce the recirculation amount of the low-pressure EGR gas when only a relatively small amount of condensed water is retained in the low-pressure EGR passage 51 does not significantly diminish the NOx reduction effect. In contrast, in an operating region in which the NOx reduction effect by recirculating the low-pressure EGR gas to the intake passage 13 is relatively high, executing such control at a stage when only a small amount of condensed water is present in the low-pressure EGR passage 51 would lead to a decrease in the NOx reduction effect.

To address this, the controller 60 identifies the operating region of the internal combustion engine 10 based on the engine torque TQ and engine rotation speed NE. The controller 60 calculates a residual amount Qwc that is an estimated value of an amount of condensed water remaining in the low-pressure EGR passage 51. Then, when the residual amount Qwc exceeds a determination value corresponding to the identified operating region, the controller 60 operates the low-pressure EGR device 50 to reduce the recirculation amount of the low-pressure EGR gas.

Thus, the timing for initiating the process of reducing the recirculation amount of the low-pressure EGR gas is determined based on a comparison between the residual amount Qwc and the determination value corresponding to the current operating region. As a result, unlike devices that fix the determination value regardless of the operating region, the exhaust gas recirculation system 100 is capable of appropriately adjusting the timing for reducing the recirculation amount of the low-pressure EGR gas recirculation. Accordingly, the exhaust gas recirculation system 100 discharges condensed water generated in the low-pressure EGR passage 51 into the exhaust passage 16, while suppressing a decrease in the NOx reduction effect.
(2) The first operating region DA1 is an operating region in which recirculation of the high-pressure EGR gas to the intake passage 13 is prohibited. In contrast, the second operating region DA2 is an operating region in which both the high-pressure EGR gas and the low-pressure EGR gas are allowed to be recirculated to the intake passage 13.

Accordingly, in the exhaust gas recirculation system 100, the determination values QwcThA and QwcThB corresponding to the second operating region DA2 are set lower than the determination value QwcThC corresponding to the first operating region DA1.

Therefore, when the current operating region is the first operating region DA1, the process of reducing the recirculation amount of the low-pressure EGR gas is less likely to be executed at a stage at which the residual amount Qwc is small, as compared to when the current operating region is the second operating region DA2. This allows the exhaust gas recirculation system 100 to suppress a decrease in the NOx reduction effect.

In contrast, when the current operating region is the second operating region DA2, the process of reducing the recirculation amount of the low-pressure EGR gas is executed at a stage at which the residual amount Qwc is small, as compared to when the current operating region is the first operating region DA1. As a result, the exhaust gas recirculation system 100 reduces the amount of condensed water retained in the low-pressure EGR passage 51.
(3) The second operating region DA2 is divided into the third operating region DA3 and the fourth operating region DA4. The fourth operating region DA4 is an operating region in which the NOx reduction effect by recirculating the low-pressure EGR gas into the intake passage 13 is lower than that in the third operating region DA3.

Therefore, in the exhaust gas recirculation system 100, the determination value QwcThA corresponding to the fourth operating region DA4 is set lower than the determination value QwcThB corresponding to the third operating region DA3. Accordingly, when the current operating region is the fourth operating region DA4, the process of reducing the recirculation amount of the low-pressure EGR gas is executed at a stage at which the residual amount Qwc is smaller than that in a case in which the current operating region is the third operating region DA3. Accordingly, the exhaust gas recirculation system 100 discharges condensed water generated in the low-pressure EGR passage 51 into the exhaust passage 16, while suppressing a decrease in the NOx reduction effect.
(4) The controller 60 calculates the generation amount Qwg and the discharge amount Qwd at predetermined control cycles. Then, the controller 60 calculates the residual amount Qwc by accumulating the difference between the generation amount Qwg and the discharge amount Qwd. At this time, the controller 60 calculates, as the discharge amount Qwd, the sum of the first discharge amount Qwd1, which is the discharge amount of condensed water from the low-pressure EGR passage 51 to the intake passage 13, and the second discharge amount Qwd2 of condensed water from the low-pressure EGR passage 51 to the exhaust passage 16. By calculating the discharge amount Qwd in consideration of the second discharge amount Qwd2 in addition to the first discharge amount Qwd1, the exhaust gas recirculation system 100 increases the accuracy of the calculation of the residual amount Qwc.

### Modifications

The above-described embodiment may be modified as described below. The above-described embodiment and the following modifications can be combined as long as the combined modifications remain technically consistent with each other.

The controller 60 does not necessarily need to calculate the second discharge amount Qwd2 when calculating the discharge amount Qwd. For example, the controller 60 may calculate the discharge amount Qwd by increasing the first discharge amount Qwd1 in accordance with execution time during which the process of reducing the opening degree of the low-pressure EGR valve 53 is executed. The controller 60 preferably calculates the discharge amount Qwd by correcting the first discharge amount Qwd1 such that the amount of increase increases as the execution time becomes longer.

The determination value QwcThA corresponding to the fourth operating region DA4 may be equal to the determination value QwcThB corresponding to the third operating region DA3.

In steps S27 and S35 shown in FIG. 4, the controller 60 does not necessarily need to close the low-pressure EGR valve 53 as long as the amount of the low-pressure EGR gas recirculated to the intake passage 13 can be reduced.

The controller 60 is not limited to a device that includes a CPU and a ROM and executes software processing. That is, the controller 60 may have any one of the following configurations (a), (b), and (c).
(a) The controller 60 includes one or more processors that execute various processes according to computer programs. Each processor includes a CPU and a memory, such as a RAM and a ROM. The memory stores program codes or instructions configured to cause the CPU to execute processes. The memory, or a computer-readable medium, includes any type of medium that is accessible by general-purpose computers and dedicated computers.
(b) The controller 60 includes one or more dedicated hardware circuits that execute various processes. Examples of the dedicated hardware circuits include an application specific integrated circuit (ASIC) and a field programmable gate array (FPGA).
(c) The controller 60 includes one or more processors that execute part of various processes according to programs and one or more dedicated hardware circuits that execute the remaining processes.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An exhaust gas recirculation system configured to be provided in an internal combustion engine including a cylinder, an intake passage through which air introduced into the cylinder flows, an exhaust passage through which exhaust gas discharged from the cylinder flows, and a forced-induction device that compresses the air flowing through the intake passage, wherein
the forced-induction device includes a turbine provided in the exhaust passage and a compressor provided in the intake passage and operates in synchronization with the turbine,
the exhaust gas recirculation system comprises:
a high-pressure EGR device that recirculates exhaust gas flowing through the exhaust passage to the intake passage as high-pressure EGR gas;
a low-pressure EGR device that recirculates exhaust gas flowing through the exhaust passage to the intake passage as low-pressure EGR gas; and
a controller configured to control the high-pressure EGR device and the low-pressure EGR device so as to adjust a recirculation amount of the high-pressure EGR gas and a recirculation amount of the low-pressure EGR gas,
the high-pressure EGR device includes a high-pressure EGR passage,
a first end of the high-pressure EGR passage is connected to a section of the exhaust passage upstream of the turbine,
a second end of the high-pressure EGR passage is connected to a section of the intake passage downstream of the compressor,
the low-pressure EGR device includes a low-pressure EGR passage and a cooling device,
a first end of the low-pressure EGR passage is connected to a section of the exhaust passage downstream of the turbine,
a second end of the low-pressure EGR passage is connected to a section of the intake passage upstream of the compressor,
the cooling device cools the low-pressure EGR gas flowing through the low-pressure EGR passage, and
the controller is configured to
identify an operating region of the internal combustion engine based on an output torque and an engine rotation speed of the internal combustion engine;
calculate a residual amount that is an estimated value of an amount of condensed water remaining in the low-pressure EGR passage; and
when the residual amount is greater than a determination value corresponding to the operating region, operate the low-pressure EGR device so as to reduce the recirculation amount of the low-pressure EGR gas.

2. The exhaust gas recirculation system according to claim 1, wherein
the operating region includes:
a first operating region in which the high-pressure EGR gas is prohibited from being recirculated to the intake passage is prohibited; and
a second operating region in which both the high-pressure EGR gas and the low-pressure EGR gas are allowed to be recirculated to the intake passage; and
the determination value corresponding to the second operating region is less than the determination value corresponding to the first operating region.

3. The exhaust gas recirculation system according to claim 2, wherein
the second operating region includes:
a third operating region; and
a fourth operating region in which an effect of improving exhaust emission characteristics by recirculating the low-pressure EGR gas to the intake passage is lower than in the third operating region, and
the determination value corresponding to the fourth operating region is less than the determination value corresponding to the third operating region.

4. The exhaust gas recirculation system according to claim 1, wherein
the controller estimates a generation amount of the condensed water in the low-pressure EGR passage and a discharge amount of the condensed water from the low-pressure EGR passage at specified control cycles,
the controller is configured to derive the residual amount by accumulating a difference between the generation amount and the discharge amount at the control cycles, and
the controller is configured to calculate, as the discharge amount, a sum of a discharge amount of condensed water from the low-pressure EGR passage to the exhaust passage and a discharge amount of condensed water from the low-pressure EGR passage to the intake passage.
